(19) United States
(12) Patent Application Publication
(10) Pub. No.: US 2026/0361538 A1
(43) Pub. Date: Nov. 12, 2026

(54) Recognition-Enhanced Cryptographic Audit: Spectral-Factor Detection for RSA Moduli

(71) Applicant: Jonathan Washburn, Austin, TX (US)

(72) Inventor: Jonathan Washburn, Austin, TX (US)

(21) Appl. No.: 19/651,734

(22) Filed: Apr. 19, 2026

Related U.S. Application Data
(60) Provisional application No. 63/794,557, filed on Apr. 25, 2025.

(51) Int. Cl. H04L 9/30; H04L 9/08

(52) U.S. Cl. CPC H04L 9/302; H04L 9/0877

(57) ABSTRACT

A computer-implemented method audits an RSA modulus without factorization by embedding the modulus into a modulus-dependent spectral problem, computing a plurality of eigenvalues, comparing the computed eigenvalues with a stored prime-like reference spectrum, computing a spectral-factor score representing deviation from the reference spectrum, and classifying the modulus according to the score. In preferred embodiments, the modulus is embedded by applying periodic boundary conditions of period N to a recognition operator, and classification is performed using a fixed threshold to generate a PASS or FLAG result. Preferred implementations use discretization and iterative eigenvalue computation, including Lanczos-Krylov processing and optional FFT-based operations. The method may be implemented in a local audit tool, network service, key-generation gate, or hardware security environment to identify structurally weak, malformed, or maliciously constructed RSA moduli.

### CROSS-REFERENCE TO RELATED APPLICATIONS

Pursuant to 35 U.S.C. 119(e), this application claims the benefit of U.S. Provisional Patent Application No. 63/794,557, filed on Apr. 25, 2025, and titled “Recognition-Enhanced Cryptographic Audit: Spectral-Factor Detection for RSA Moduli,” the entire disclosure of which is incorporated herein by reference.

### BACKGROUND

The present disclosure relates generally to cryptographic compliance testing, RSA modulus integrity auditing, and public-key infrastructure assurance. More particularly, the present disclosure relates to systems and methods for detecting structurally weak, malformed, or maliciously constructed RSA moduli without factorization by using recognition-operator spectral analysis.

RSA security depends on the difficulty of factoring a modulus N formed as the product of two large primes p and q. In practice, however, an RSA modulus can be vulnerable even when conventional front-end checks appear satisfactory. Weakness may arise from predictable prime-generation structure, near-prime construction, near-square form, smooth substructure, correlated generation processes, or deliberately inserted backdoor structure.

Existing audit techniques are incomplete for this purpose. Probabilistic primality testing, such as Miller-Rabin testing, can confirm that candidate factors appear prime, but does not diagnose whether the resulting modulus has structural weakness that makes it abnormally susceptible to attack. Batch greatest-common-divisor analysis can identify shared factors across large key populations, but generally fails to identify single-key weakness when the modulus does not share factors with another audited modulus. Trial division, elliptic-curve factorization methods, and related factor-recovery approaches are too slow or resource-intensive for many bulk audit settings.

Real-world examples illustrate this gap. Coppersmith-exploitable constructions can produce keys that are formally prime at the factor level while still being structurally weak. ROCA-type key-generation flaws can produce moduli with predictable prime structure. Near-square semiprimes and related constructions can also be significantly weaker than structurally sound RSA moduli, even though conventional primality-focused checks do not identify the resulting modulus as suspicious.

Accordingly, there is a need for a cryptographic audit method that screens individual RSA moduli at scale, detects structural weakness without requiring factorization, does not depend on shared-factor databases, and can be deployed in certificate audit, key-generation assurance, hardware security module, and related public-key infrastructure environments.

The present disclosure addresses that need by treating the modulus as an input to a recognition-operator spectral problem and using the resulting spectral response as a factor-structure diagnostic rather than an integer-factorization method. In this approach, the modulus is embedded into a spectral problem whose deviation from a prime-like reference reveals whether the modulus behaves like a high-integrity RSA modulus or instead exhibits suspicious structural regularity.

### SUMMARY

In one aspect, the present disclosure provides a computer-implemented method for auditing an RSA modulus without factorization by imposing modulus-dependent periodic boundary conditions on a recognition operator, computing a modulus-dependent eigen-spectrum, comparing that spectrum with a fixed prime-like reference spectrum, computing a spectral-factor score, and classifying the modulus based on that score. The core of the invention is the spectral audit kernel itself, namely recognition-operator embedding, spectral-factor scoring, classification, and associated implementation pathways that preserve that kernel.

In a preferred embodiment, the recognition-physics operator is defined as H_RP=−d\hat{ }2/dx\hat{ }2+cosh(x)31 1, and the RSA modulus N is embedded by imposing periodic boundary conditions psi(x+N)=psi(x) and psi′(x+N)=psi′(x) over an interval [0, N). This produces a finite, modulus-dependent spectral problem having eigenvalues lambda_k(N), from which a selected set of eigenvalues is computed for audit use.

In a preferred scoring embodiment, a stored prime-like reference spectrum lambda_k_ref is generated from certified high-integrity reference instances and fixed for a release. A spectral-factor score S(N) is then computed as S(N)=sqrt((1/K) sum over k of (lambda_k(N)−lambda_k_ref)\hat{ }2), optionally after unfolding or normalization. The score is nonnegative, and classification is performed using a fixed threshold tau. In a preferred disclosed embodiment, PASS is assigned if S(N)<=tau and FLAG is assigned if S(N)>tau, with tau=0.007 fixed per release and not tuned per key size.

The disclosed audit is deterministic under a fixed release configuration and detects structural weakness that primality-only checks can miss. The spectrum functions as a factor-structure diagnostic rather than an integer-factorization method. As disclosed, the method can identify suspicious structures associated with, for example, Coppersmith-style weakness, ROCA-type constructions, and near-square semiprime structure, while permitting structurally sound RSA moduli to pass.

In preferred numerical implementations, the embedded spectral problem is discretized on a finite grid, optionally using a power-of-two grid, and eigenvalues are extracted using Lanczos-Krylov methods, optionally with FFT-enabled matrix-vector operations, selective reorthogonalization, and Rayleigh-quotient refinement. In a preferred disclosed implementation, K=256 eigenvalues are computed using a discretization with M=2\hat{ }14 grid points. These numerical details provide strong fallback support and enable high-throughput realization, but do not alter the identity of the core invention.

In additional aspects, the disclosure provides systems, non-transitory computer-readable media, audit services, and key-generation gate embodiments that implement the spectral audit kernel. Example deployment forms include command-line audit tools, microservice endpoints, PKCS #11 key-generation interception, hardware security module integration, certificate authority database auditing, certificate-transparency monitoring, and smart-card vetting. These embodiments remain subordinate to the core invention, which is the non-factorization spectral audit of RSA moduli.

In further aspects, the disclosure preserves optional, alternative, and future-facing embodiments, including batch-mode cross-modulus analysis, equivalent numerical realizations that preserve the same spectral audit kernel, and continuation-oriented extensions to other cryptographic domains. Such embodiments do not redefine the present invention and are presented separately from the core RSA audit mechanism.

Formal verification anchors and empirical validation support are also disclosed. In particular, disclosed formal anchors include score_nonneg, threshold_fixed, and threshold_positive, while disclosed validation support includes benchmark throughput, observed false-positive behavior on reference corpora, and detection examples involving multiple attack-relevant modulus classes. These materials strengthen technical credibility and prosecution support while remaining distinct from the core claim identity.

### BRIEF DESCRIPTION OF THE FIGURES

FIG. 1 is a block diagram of an example cryptographic audit system configured to receive an RSA modulus, compute a modulus-dependent spectral score, and output a modulus integrity classification.

FIG. 2 is a schematic diagram showing embedding of a modulus into a recognition-physics operator with periodic boundary conditions determined by the modulus N.

FIG. 3 is a flow diagram of an example numerical realization including discretization, FFT-enabled matrix-vector operations, Lanczos eigenvalue extraction, and eigenvalue refinement.

FIG. 4 is a diagram showing reference spectrum generation, storage, and use during audit classification.

FIG. 5 is a diagram showing score computation and classification logic including a fixed threshold and PASS/FLAG output rule.

FIG. 6 is a comparative conceptual figure showing prime-like spectral behavior versus suspicious structural deviation behavior for different RSA modulus classes.

FIG. 7 is a deployment architecture diagram showing command-line, microservice, PKCS #11, hardware security module, certificate authority, certificate-transparency monitoring, and smart-card embodiments.

FIG. 8 is a key-generation gate flow diagram showing regeneration or release of a candidate keypair based on spectral audit outcome.

FIG. 9 is an optional batch-analysis figure showing per-modulus scoring and optional cross-modulus spectral correlation.

FIG. 10 is a validation and benchmark framework figure showing reference corpus testing, attack-class testing, false-positive measurement, and throughput benchmarking.

### DETAILED DESCRIPTION

Referring now to the drawings, in which like numerals indicate like elements, the present disclosure provides systems and methods for auditing an RSA modulus without factorization by embedding the modulus into a recognition-operator spectral problem, computing a modulus-dependent eigen-spectrum, comparing that spectrum with a fixed prime-like reference spectrum, computing a spectral-factor score, and classifying the modulus as PASS or FLAG. The invention is centered on that spectral audit kernel. Packaging, deployment channel, and downstream use context remain subordinate to that kernel.

In preferred embodiments, the disclosed audit framework may be understood as comprising four coordinated components: (i) recognition-operator embedding of the RSA modulus into a modulus-dependent spectral problem, (ii) computation of a spectral-factor score from a modulus-dependent eigen-spectrum relative to a fixed prime-like reference spectrum, (iii) classification of the modulus according to a fixed threshold, and (iv) tooling or deployment infrastructure configured to apply the foregoing audit kernel in a compliance, certificate, key-generation, or related environment.

In the disclosed approach, an RSA modulus is treated as a structural input to a spectral problem rather than merely as a numeric value to be checked against a blacklist, compared against a shared-factor database, or subjected to direct factor-recovery operations. The modulus influences the boundary structure of a recognition-physics operator, and the resulting spectral response is used as a diagnostic of factor integrity and structural weakness.

As used herein, “RSA modulus” refers to a composite integer N used in an RSA cryptosystem, typically formed as the product of two primes p and q. As used herein, “prime-like modulus” refers to an RSA modulus whose spectral response conforms, within the disclosed scoring framework, to a stored reference corresponding to structurally sound or high-integrity RSA moduli. As used herein, “suspicious modulus” refers to a modulus whose spectral response deviates sufficiently from that stored reference to satisfy a flagging criterion.

As used herein, “recognition operator” refers to the operator used to generate the disclosed modulus-dependent spectral problem. In a preferred embodiment, the recognition operator is a recognition-physics operator H_RP defined by H_RP=−d\hat{ }2/dx\hat{ }2+cosh(x)−1. As used herein, “reference spectrum” refers to a stored spectral baseline derived from certified high-integrity reference instances. As used herein, “spectral-factor score” refers to a scalar score representing deviation between a modulus-dependent test spectrum and the stored reference spectrum.

As used herein, “PASS” refers to an audit result indicating that the tested modulus is sufficiently prime-like under the disclosed scoring framework, and “FLAG” refers to an audit result indicating that the tested modulus is suspicious under that scoring framework. As used herein, “fixed threshold” refers to a threshold set for a release and not tuned on a per-key or per-key-size basis. As used herein, “release-specific reference” refers to a stored reference spectrum and associated threshold configuration bound to a particular software, firmware, appliance, or service release.

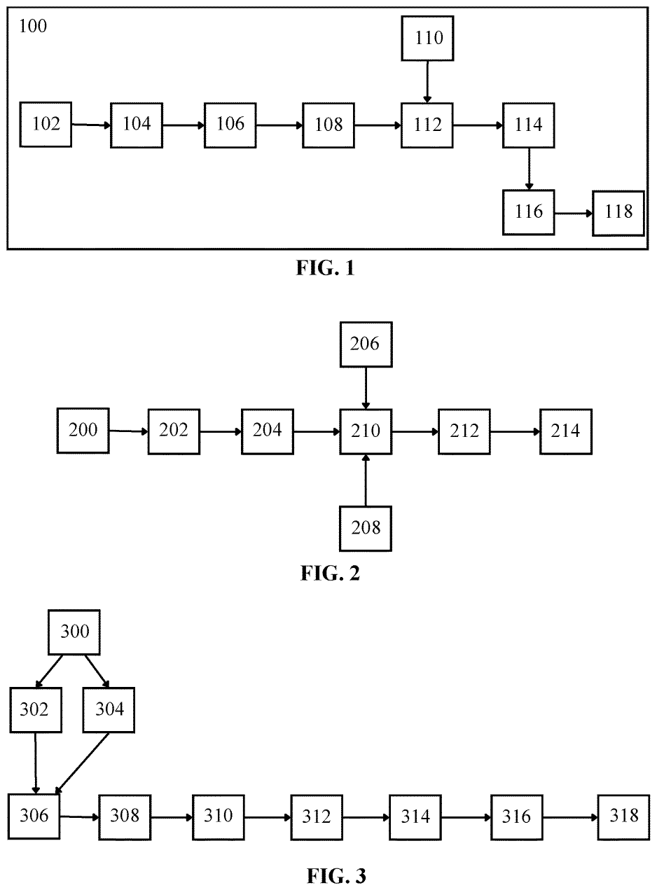

FIG. 1 depicts an example cryptographic audit system 100. In the illustrated embodiment, system 100 includes an RSA modulus input 102, a modulus extraction or parser module 104, a recognition-operator embedding engine 106, an eigenvalue computation engine 108, a reference spectrum store 110, a spectral-factor score engine 112, a classifier 114, an output generator 116, and a deployment interface 118.

In operation, RSA modulus input 102 may receive a raw modulus value, a certificate, a public key object, a private key container, a candidate keypair, a hardware-generated key record, or another structure containing an RSA modulus. Parser module 104 extracts or otherwise obtains the modulus N and converts it into an internal representation suitable for spectral processing.

Embedding engine 106 receives the modulus N from parser module 104 and constructs a modulus-dependent recognition-operator problem in which the modulus defines the boundary period of the operator problem. Eigenvalue computation engine 108 computes a selected portion of the resulting spectrum. Reference spectrum store 110 provides a fixed prime-like reference spectrum for comparison. Score engine 112 computes a spectral-factor score from the test spectrum and the stored reference. Classifier 114 applies a fixed threshold to determine whether the modulus should be passed or flagged. Output generator 116 produces one or more outputs, including a score, a threshold value, a classification result, and optional recommendation or audit-record data. Deployment interface 118 exposes the result through a local tool, service, plugin, hardware environment, or other implementation path.

FIG. 1 therefore illustrates the principal logical flow of the disclosed audit architecture: obtain a modulus, embed the modulus into a recognition-operator spectral problem, compute an eigen-spectrum, compare the spectrum with a stored reference, compute a score, classify the modulus, and output the result. The particular packaging of these stages may vary, but the spectral audit kernel remains the same.

FIG. 2 depicts a preferred modulus-embedding arrangement 200. In the illustrated embodiment, modulus N is represented at 200, interval domain [0, N) is represented at 202, the recognition-physics operator H_RP is represented at 204, the periodic boundary condition psi(x+N)=psi(x) is represented at 206, the derivative periodic boundary condition psi′(x+N)=psi′(x) is represented at 208, the resulting finite spectral problem is represented at 210, the modulus-dependent eigenvalue set is represented at 212, and the resulting structural response of the embedded operator is represented at 214.

In a preferred embodiment, the recognition operator is the recognition-physics operator H_RP=−d\hat{ }2/dx\hat{ }2+cosh(x)−1. The modulus N is used to define interval domain 202 and to impose the periodic boundary conditions 206 and 208. This produces finite spectral problem 210 having discrete eigenvalues 212 that depend on the tested modulus.

FIG. 2 illustrates that the modulus is not merely metadata, labeling information, or a key-database entry. Instead, the modulus is embedded directly into the boundary structure of the spectral problem. The spectral response represented at 214 is therefore modulus-dependent and may reflect structural regularities, weaknesses, anomalies, or maliciously inserted structure in the modulus.

In preferred embodiments, the modulus-dependent spectrum may be represented as lambda_1(N), lambda_2(N), lambda_3(N), and so on. Only a selected subset of eigenvalues may be used for scoring. In particularly preferred embodiments, the first K eigenvalues are used, where K is at least 128 and more preferably 256.

FIG. 3 depicts a preferred numerical realization 300 for solving the embedded spectral problem. In the illustrated embodiment, grid generator 300 creates a discretized domain, kinetic-term discretization block 302 discretizes the kinetic portion of the operator, potential-term discretization block 304 discretizes the potential portion, wrapped circulant-plus-diagonal structure 306 represents a periodic matrix form compatible with the disclosed boundary conditions, FFT matrix-vector engine 308 performs efficient transform-assisted operations, Lanczos-Krylov iteration block 310 computes candidate eigen-information, selective reorthogonalization block 312 improves numerical stability, Ritz value extraction block 314 extracts candidate eigenvalues, Rayleigh-quotient refinement block 316 refines such eigenvalues, and output eigenvalue sequence 318 provides the spectrum used for scoring.

In one preferred implementation, grid generator 300 produces M=2\hat{ }14 uniformly spaced points over the interval [0, N). Kinetic-term discretization block 302 may use central differences or another finite representation of the second derivative. Potential-term discretization block 304 may represent the potential term diagonally. Structure 306 reflects the periodic wrap-around induced by the modulus-based boundary conditions.

FFT matrix-vector engine 308 may exploit the periodic or circulant aspects of the discretized representation to accelerate iterative computation. Lanczos-Krylov iteration block 310 may begin with a random or pseudo-random starting vector and build a Krylov subspace over a selected number of iterations. In a preferred embodiment, 256 iteration steps are used.

Selective reorthogonalization block 312 may be invoked periodically, such as every 50 steps, to improve numerical stability and reduce loss of orthogonality. Ritz value extraction block 314 produces candidate eigenvalues from the reduced representation. Refinement block 316 may apply Rayleigh-quotient iteration or another improvement technique before output eigenvalue sequence 318 is delivered to the score engine.

FIG. 3 therefore depicts one preferred implementation path for obtaining the modulus-dependent eigen-spectrum. Other numerical implementations may be used, provided that they preserve the disclosed spectral audit kernel and generate eigen-information suitable for comparison with the fixed reference spectrum.

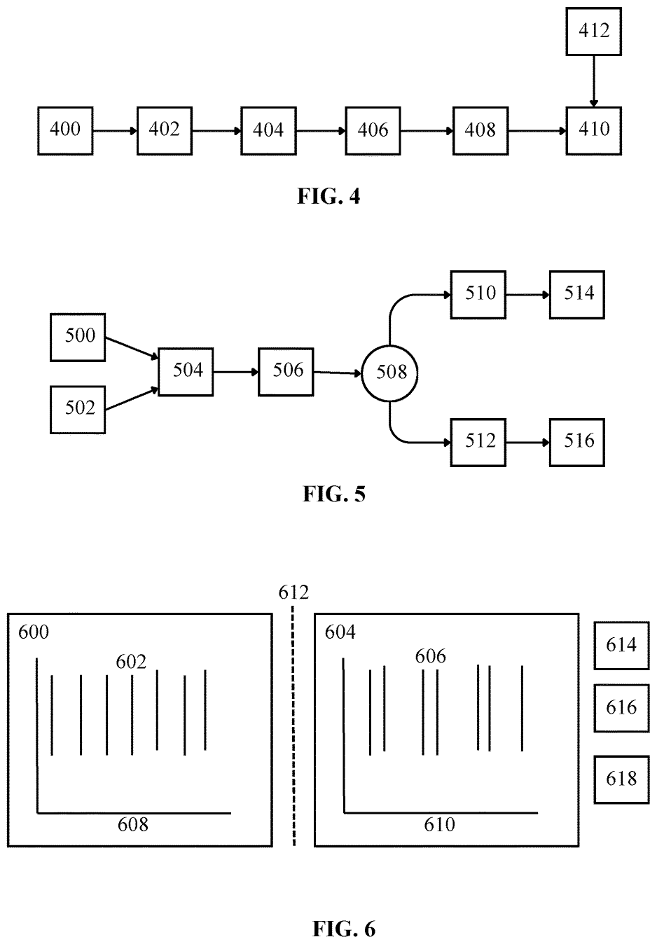

FIG. 4 depicts reference spectrum generation and storage. In the illustrated embodiment, certified reference corpus 400 provides a set of high-integrity reference instances, reference-instance selector 402 chooses one or more such instances for processing, optional normalization or unfolding block 404 performs any selected normalization procedure, repeated eigenvalue computation block 406 computes eigenvalue sequences for the selected reference instances, aggregate reference spectrum generator 408 produces a prime-like reference spectrum, fixed reference spectrum store 410 stores that reference, and release version identifier 412 associates the reference with a particular release.

In a preferred embodiment, certified reference corpus 400 contains moduli believed or verified to be structurally sound within the intended deployment range. Selector 402 may choose all such instances or a selected subset. Repeated eigenvalue computation block 406 may use the same or substantially similar numerical workflow disclosed with respect to FIG. 3.

Optional normalization or unfolding block 404 may be used where desired to improve comparability across modulus sizes, corpus compositions, or deployment populations. Such normalization or unfolding remains optional. Aggregate reference spectrum generator 408 may average, combine, or otherwise aggregate the computed reference eigenvalue sequences into a stored sequence lambda_k_ref.

Fixed reference spectrum store 410 holds the resulting reference for audit use. In preferred embodiments, the reference spectrum is computed once for a release and stored for repeated audit use. Release version identifier 412 may store or associate one or more of a release number, threshold value, eigenvalue count, normalization policy, implementation version, or related metadata. In preferred embodiments, the reference is fixed per release and is not recomputed on a per-modulus basis during ordinary audit operation.

FIG. 5 depicts score computation and classification logic. In the illustrated embodiment, test eigenvalue sequence 500 and reference eigenvalue sequence 502 are supplied to deviation computation block 504, which produces RMS score output S(N) at 506. Fixed threshold tau is represented at 508. PASS branch 510 and FLAG branch 512 correspond to threshold comparison outcomes. Action or recommendation output 514 and audit record output 516 represent optional downstream outputs.

In a preferred embodiment, deviation computation block 504 computes the score according to S(N) =sqrt((1/K) sum over k from 1 to K of (lambda_k(N)−lambda_k_ref)\hat{ }2). In some embodiments, the comparison is performed directly on eigenvalue sequences. In optional embodiments, one or both sequences may be normalized, unfolded, or otherwise preprocessed before scoring.

Fixed threshold 508 is used by classifier logic to determine the audit result. In a preferred embodiment, PASS branch 510 is selected when S(N) is less than or equal to tau, and FLAG branch 512 is selected when S(N) is greater than tau. In a particularly preferred implementation, tau=0.007. Action or recommendation output 514 may include, for example, a regenerate-key recommendation, a review instruction, a remediation suggestion, or a policy-triggered control output. Audit record output 516 may include one or more of modulus identifier, score, threshold, eigenvalue count, classification result, release identifier, timestamp, or implementation metadata.

FIG. 5 thus illustrates the disclosed transition from modulus-dependent spectrum to scalar score, from scalar score to threshold comparison, and from threshold comparison to a concrete audit result.

This score-and-classification arrangement is a central part of the invention.

In preferred embodiments, the score is nonnegative, the threshold is fixed for a release, and the threshold is positive. In preferred release configurations, the same modulus evaluated under the same fixed reference and numerical configuration yields the same score and the same PASS or FLAG result.

FIG. 6 depicts a comparative conceptual representation of prime-like versus suspicious spectral behavior. In the illustrated embodiment, prime-like modulus class 600 is associated with prime-like spectral profile 602, suspicious modulus class 604 is associated with suspicious spectral profile 606, low-score region 608 and high-score region 610 illustrate relative score placement, classification boundary 612 illustrates a threshold-based separation, and example suspicious classes include Coppersmith-type example 614, ROCA-type example 616, and near-square example 618.

FIG. 6 is conceptual rather than limiting. It illustrates that structurally sound or high-integrity moduli may cluster in low-score region 608, while structurally weak, malformed, or backdoored moduli may occupy high-score region 610. Classification boundary 612 represents a threshold-based separation, which in preferred embodiments may correspond to the fixed threshold tau used by the release.

Coppersmith-type example 614 represents a class of moduli in which structural weakness may exist even though conventional primality-focused checks do not expose a defect. ROCA-type example 616 represents a class of predictable prime-generation failures. Near-square example 618 represents a class of moduli whose factor relationships may create weakness even though the modulus remains a semiprime. The disclosed spectral audit may flag such classes based on deviation from the fixed prime-like reference.

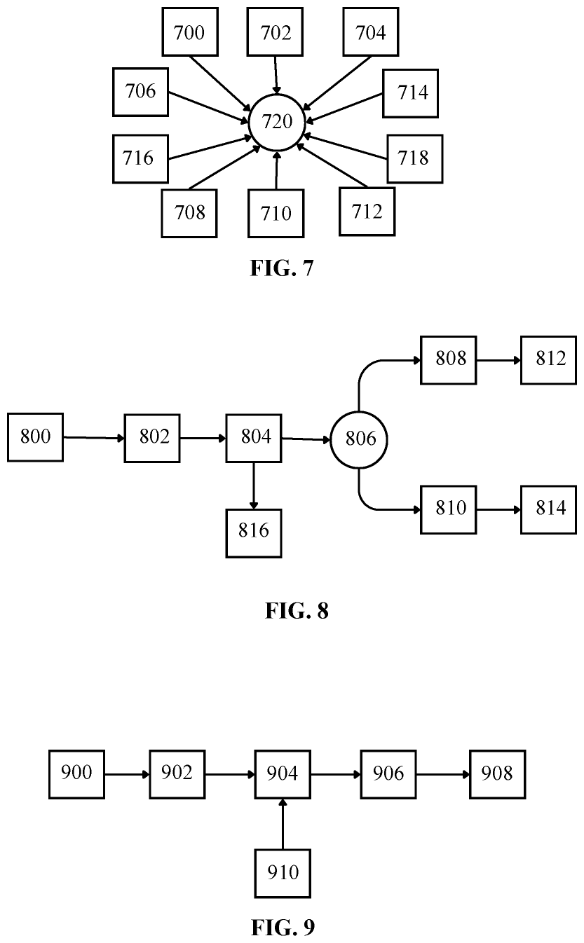

FIG. 7 depicts example deployment architecture. In the illustrated embodiment, deployment hub 720 is configured to apply the disclosed spectral audit kernel across multiple deployment paths.

Command-line auditor 700, REST service 702, optional gRPC service 704, certificate or key input source 706, PKCS #11 plugin 708, HSM embodiment 710, certificate-authority database source 712, certificate-transparency monitoring source 714, smart-card key source 716, and audit log or compliance output 718 are shown as example deployment paths coupled to deployment hub 720.

Command-line auditor 700 may be used for local compliance review, certificate inventory analysis, incident response, or key-file inspection. REST service 702 and optional gRPC service 704 may expose the disclosed audit kernel over a network interface. Certificate or key input source 706 may supply files, objects, messages, or records containing one or more RSA moduli.

PKCS #11 plugin 708 may be used in a key-generation or key-management workflow to intercept candidate keys or moduli and apply the disclosed audit before release. HSM embodiment 710 may embed the audit kernel into firmware, appliance logic, or trusted execution infrastructure. Certificate-authority database source 712 and certificate-transparency monitoring source 714 illustrate large-scale certificate-audit workflows. Smart-card key source 716 illustrates device or supply-chain vetting workflows. Compliance output 718 illustrates optional downstream logging, alerting, attestation, or review behavior.

FIG. 7 is intended to show that deployment hub 720 may package the same spectral audit kernel in multiple deployment forms without changing the core invention. None of these deployment paths is required to the broadest understanding of the invention.

FIG. 8 depicts a key-generation gate embodiment. In the illustrated embodiment, key generation engine 800 produces candidate modulus 802, spectral audit block 804 applies the disclosed audit, threshold comparator 806 determines whether the candidate satisfies the release threshold, PASS release path 808 leads to released keypair 812, FAIL or regenerate path 810 leads to regeneration behavior, signed audit log 814 stores or emits an audit trail, and policy control 816 may govern retry count, rejection behavior, escalation, or other administrative rules.

In operation, candidate modulus 802 is supplied to spectral audit block 804 before the corresponding keypair is released. Threshold comparator 806 applies the fixed threshold logic. If the candidate passes, the process follows release path 808 and outputs released keypair 812. If the candidate fails, the process follows regenerate path 810 and may invoke additional generation or rejection logic under policy control 816.

Signed audit log 814 may record one or more of modulus identifier, score, threshold, result, timestamp, release identifier, hardware identity, or attestation data. The key-generation gate embodiment of FIG. 8 is commercially significant, but remains an embodiment of the same underlying spectral audit kernel.

FIG. 9 depicts an optional batch-mode multi-modulus analysis embodiment. In the illustrated embodiment, plurality of moduli 900 are supplied to per-modulus score outputs 902, optional spectral-correlation engine 904 processes one or more inter-modulus relationships, family-level anomaly detector 906 identifies correlation patterns or related anomalies, shared-factor or correlation report 908 records the result, and batch audit controller 910 coordinates operation.

The per-modulus scoring stage 902 remains part of the core disclosed audit kernel. By contrast, optional spectral-correlation engine 904 and detector 906 represent an extension that may be used where a deployment wishes to evaluate families of moduli for shared generation defects, shared-factor patterns, or related anomalies. This batch-mode analysis is optional and does not redefine the core invention.

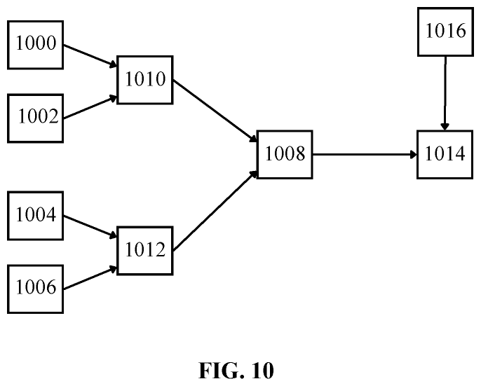

FIG. 10 depicts a validation and benchmark framework. In the illustrated embodiment, certified reference corpus test 1000, Coppersmith-style corpus test 1002, ROCA-style corpus test 1004, red-team blind test 1006, throughput benchmark harness 1008, false-positive measurement block 1010, true-positive measurement block 1012, benchmark report generator 1014, and optional release validation gate 1016 are shown.

Certified reference corpus test 1000 may be used to characterize behavior on high-integrity moduli and to observe false-positive performance. Coppersmith-style corpus test 1002 and ROCA-style corpus test 1004 may be used to characterize suspicious-structure detection. Red-team blind test 1006 may evaluate mixed-population classification behavior under concealed ground truth. Throughput benchmark harness 1008 may characterize processing rate, latency, or resource usage. False-positive measurement block 1010 and true-positive measurement block 1012 may generate validation metrics, which benchmark report generator 1014 may present in human-readable, machine-readable, or release-bound form. Optional release validation gate 1016 may be used to determine whether a fixed reference and threshold configuration should be approved for deployment. The foregoing figures illustrate preferred and optional embodiments in a drawing-supported manner. Additional implementation detail is set forth below.

In one implementation, the system receives as input either a raw RSA modulus or a source object containing an RSA modulus, such as a certificate, public key, private key container, candidate keypair, hardware-generated key record, or equivalent source. The system extracts or otherwise obtains the modulus N and converts it into an internal representation suitable for spectral processing.

In preferred embodiments, preprocessing may include parsing an input file or protocol object, extracting modulus bytes or words, validating that the input corresponds to an RSA modulus, identifying modulus size, normalizing representation, and passing the modulus to the embedding engine. Such preprocessing is useful for implementation but does not alter the identity of the core invention.

The disclosed workflow may include the stages of input acquisition, modulus extraction, modulus validation, operator embedding, discretization, eigenvalue extraction, optional normalization or unfolding, reference comparison, score computation, threshold comparison, classification, output generation, and optional downstream action. Any one or more of these stages may be implemented in software, firmware, hardware, or mixed form, provided that the disclosed spectral audit kernel is preserved.

In a preferred embodiment, the operator H_RP is restricted to an interval [0, N), where N is the RSA modulus under test. The modulus is therefore not merely used as metadata or as an index into a lookup table. Instead, the modulus determines the period of the boundary conditions applied to the operator, thereby producing a modulus-dependent spectral problem.

In a preferred embodiment, the embedding is performed by imposing periodic boundary conditions according to psi(x+N)=psi(x) and psi′(x+N)=psi′(x). These boundary conditions produce a finite eigenvalue problem having a discrete spectrum that depends on the modulus N.

In preferred embodiments, the modulus-dependent spectrum may be represented as lambda_1(N), lambda_2(N), lambda_3(N), and so on. In preferred implementations, only an initial subset of the spectrum is used for audit scoring. In a particularly preferred implementation, the first K eigenvalues are used, where K is at least 128 and more preferably 256.

The disclosed approach is based on the recognition that structurally sound RSA moduli exhibit prime-like spectral behavior under the foregoing embedding, while structurally weak, malformed, or backdoored RSA moduli produce measurable deviation from that prime-like behavior. The system therefore uses spectral deviation as a factor-structure diagnostic without recovering p or q.

The disclosed spectrum therefore functions as a factor-structure diagnostic rather than an integer-factorization method, permitting detection of structural weakness without explicit recovery of p or q and without dependence on a shared-factor database.

In benchmark embodiments, high-integrity RSA moduli exhibit prime-like or GUE-like spectral behavior under the disclosed embedding, while structured weakness, predictable generation structure, near-square form, or related anomalies introduce measurable deviation from that baseline.

In preferred embodiments, the prime-like reference is represented by a stored sequence lambda_k_ref generated from certified high-integrity reference instances. The reference may be generated once for a release and stored for repeated use. In preferred embodiments, the reference is fixed per release and used uniformly across audited moduli within the intended deployment range.

In one preferred scoring embodiment, the spectral-factor score is computed according to S(N)=sqrt((1/K) sum over k from 1 to K of (lambda_k(N)−lambda_k_ref)\hat{ }2). This score is nonnegative and measures deviation of the tested spectrum from the stored prime-like reference.

In preferred embodiments, the score may be computed directly from the eigenvalue sequences. In optional embodiments, the eigenvalue sequences may first be normalized, unfolded, rescaled, or otherwise processed to improve comparability across modulus sizes or across audit populations. Such normalization or unfolding is optional and should not be construed as mandatory to the broadest description of the invention.

In a preferred classification embodiment, the score S(N) is compared with a fixed threshold tau. The modulus is classified as PASS if S(N) is less than or equal to tau, and classified as FLAG if S(N) is greater than tau. In a particularly preferred implementation, tau=0.007.

In preferred embodiments, tau is fixed per release and is not tuned on a per-key or per-key-size basis. This fixed-threshold architecture provides repeatability, consistency, and deployment discipline. It also distinguishes the disclosed audit framework from adaptive or ad hoc scoring systems that vary classification criteria from modulus to modulus.

In preferred embodiments, the threshold is selected as a fixed release threshold from the score distribution of a certified prime-like reference population. In a particularly preferred implementation, tau=0.007 corresponds to a conservative three-sigma separation boundary for the release and is not tuned on a per-key or per-key-size basis.

The disclosed audit is deterministic under a fixed release configuration. For a given modulus N, fixed reference spectrum, fixed threshold, and fixed numerical implementation parameters, the system returns the same spectral score and the same PASS or FLAG result. This deterministic property is useful in compliance environments, audit workflows, and key-generation gating.

In preferred numerical implementations, the modulus-dependent spectral problem is discretized on a finite grid over the interval [0, N). In one preferred embodiment, the grid comprises M=2\hat{ }14 uniformly spaced points. The kinetic term may be discretized using central differences or an equivalent finite representation of the second derivative, and the potential term may be represented diagonally.

In a preferred implementation, the resulting operator representation includes periodic wrap-around structure compatible with the disclosed boundary conditions. In certain embodiments, the resulting matrix or operator form may be described as circulant-plus-diagonal or otherwise FFT-compatible, thereby permitting efficient matrix-vector products during iterative eigenvalue computation.

In preferred embodiments, eigenvalue extraction is performed using a Lanczos or related Krylov-subspace method. A preferred implementation may include a random or pseudo-random starting vector, construction of a Krylov subspace, selective reorthogonalization, extraction of Ritz values, and optional Rayleigh-quotient refinement.

In a particularly preferred embodiment, 256 iterative steps are used to generate a corresponding set of candidate eigenvalues, and selective reorthogonalization is performed periodically, such as every 50 steps. In further preferred embodiments, the resulting candidate eigenvalues are refined by one or more additional numerical procedures before being passed to the score engine.

In one preferred implementation, per-modulus computation may involve approximately 256 matrix-vector products, each having complexity on the order of M log M for an FFT-enabled realization. For a preferred grid size M=2\hat{ }14, this corresponds to approximately 5.9×10\hat{ }7 operations per modulus. At a benchmark throughput of approximately 9.5×10\hat{ }4 moduli per second, aggregate computational load remains consistent with high-performance accelerator execution.

In some implementations, the system may verify convergence or stability criteria before accepting an eigenvalue set for scoring. Such criteria may include successful generation of the target eigenvalue count, stability under refinement, internal consistency checks, or equivalent numerical acceptance tests. If desired, the system may re-run part of the numerical workflow using increased effort, altered precision, or alternate hardware. Such robustness features are optional.

The reference spectrum may be generated from a corpus of certified high-integrity moduli. In preferred embodiments, the corpus includes moduli believed or verified to be structurally sound within the intended deployment range. The system may compute spectra for those reference instances, optionally normalize or unfold the results, aggregate the results into a stored reference sequence, and bind that sequence to a release identifier.

In preferred embodiments, the reference store may also contain metadata such as modulus-size range, release identifier, threshold value, normalization policy, eigenvalue count, and numerical implementation version. These data improve reproducibility and support deterministic deployment.

In operation, the system may output one or more of: the modulus identifier, modulus size, score S(N), threshold tau, eigenvalue count K, audit result, recommendation text, audit record, or policy action. The broad invention is not limited to any specific output formatting.

In some embodiments, a PASS result results in simple output and optional logging. In some embodiments, a FLAG result may additionally trigger recommendation of modulus replacement, keypair regeneration, escalation to human review, policy-based rejection, or other action. Such downstream actions are optional consequences of classification, not the classification itself.

In disclosed embodiments, the spectral-factor score responds to structural weakness in the modulus even when such weakness is not exposed by primality-focused checks. The system therefore evaluates the modulus as a whole through its modulus-dependent spectral response rather than attempting to prove primality of hypothetical factors or recover such factors directly.

In one class of embodiments, the system is configured to identify moduli associated with Coppersmith-style weakness. By way of example, one or more factors used to generate the modulus may have a structured relationship that enables small-root or related attacks even though the factor candidates satisfy conventional primality testing. In such cases, the disclosed spectral audit can produce a score exceeding the applicable threshold and can therefore flag the modulus as suspicious.

In another class of embodiments, the system is configured to identify moduli associated with predictable prime-generation structure, including ROCA-type constructions or similar structured-generation failures. In such embodiments, the modulus may pass conventional screening that does not inspect spectral behavior, while the disclosed audit identifies deviation from the fixed prime-like reference spectrum and classifies the modulus as suspicious.

In another class of embodiments, the system is configured to identify near-square or related semiprime constructions. For example, where one factor is unusually close to another factor, or where the modulus exhibits structure associated with simplified factor-recovery procedures such as Fermat-style approaches, the spectral response may deviate sufficiently from the reference spectrum to produce a FLAG result.

In another class of embodiments, the system may be used to distinguish structurally sound RSA moduli from weak or malformed ones by comparing score ranges or score distributions. For example, prime-like or high-integrity moduli may cluster in a low-score region, while suspicious or deliberately structured moduli may occupy a higher-score region. The classification threshold may be selected to separate these regions conservatively within a given release.

In certain embodiments, the system may also be applied to moduli generated from safe-prime or otherwise legitimate RSA key-generation procedures. Such moduli may exhibit prime-like spectral behavior and may therefore be classified as PASS under the disclosed scoring framework. These examples are useful to show that the disclosed audit does not merely reject all structured or unusual modulus populations, but instead distinguishes between structurally sound and suspicious behavior according to the stored reference.

In benchmark embodiments, high-integrity or prime-like RSA moduli may produce scores concentrated near zero, such as approximately 0.002 plus or minus 0.001, while structured weak moduli may produce materially larger scores, such as approximately 0.03 plus or minus 0.01. In further benchmark embodiments, Coppersmith-style backdoor keys may produce scores greater than 0.1, and highly smooth or non-RSA stress-test composites may produce substantially larger scores. By way of example, benchmark embodiments may include a Coppersmith-style example producing a score of approximately 0.142, a ROCA-style example producing a score of approximately 0.089, a near-square example producing a score of approximately 0.031, and a safe-prime example producing a score of approximately 0.0021.

In some implementations, the system may be used in a batch environment in which many moduli are scored independently. In such embodiments, each modulus receives an individual spectral-factor score and an individual PASS or FLAG outcome. This per-modulus scoring remains part of the core disclosed audit mechanism.

In optional embodiments, a batch workflow may include additional cross-modulus analysis. For example, after per-modulus scoring is performed, an optional correlation engine may evaluate whether multiple moduli exhibit related spectral signatures, common anomalies, or family-level structure indicative of shared generation defects or shared-factor families. Such cross-modulus analysis is optional and should not be understood as required to the core invention.

In certain embodiments, the disclosed system may flag a modulus even when the modulus does not share factors with any other audited modulus, and even when no factorization is attempted. This is a significant practical distinction from batch greatest-common-divisor techniques, which generally depend on the presence of a shared factor across multiple keys.

In preferred embodiments, validation of the disclosed audit may be performed using one or more controlled corpora. Such corpora may include a certified high-integrity reference corpus, one or more weak-key corpora, one or more deliberately structured or backdoored corpora, and one or more mixed blind-test corpora. The same scoring framework may then be applied across those corpora to characterize false-positive, true-positive, throughput, and repeatability behavior.

In one validation arrangement, a certified reference corpus may be processed to confirm that high-integrity moduli remain at or below the applicable threshold under the intended release configuration. Such validation may be used to quantify observed false-positive behavior and to confirm stability of the fixed threshold within the intended deployment range.

In another validation arrangement, a weak-key corpus may include one or more Coppersmith-style examples, ROCA-type examples, near-square examples, smooth or stress-test composites, or related suspicious constructions. The system may process such corpora to confirm that the corresponding scores occupy a flagged region relative to the fixed reference.

In another validation arrangement, a blind-test corpus may be assembled by mixing structurally sound moduli with hidden suspicious moduli. The system may process the blind-test corpus without advance labeling and may then compare the resulting classifications against the hidden ground truth. Such validation is useful for measuring detection sensitivity and operational false-positive behavior in a realistic screening scenario.

In preferred embodiments, performance validation may additionally include throughput benchmarking. For example, the disclosed audit may be run on a graphics-processing unit, central-processing unit, accelerator, or mixed environment while measuring moduli processed per second, per-modulus latency, memory usage, or equivalent implementation metrics. These measurements support practical deployment and illustrate that the disclosed audit is suitable for bulk or streaming environments.

In one preferred benchmark configuration, the system may process large modulus populations using GPU hardware and may achieve high sustained throughput while preserving deterministic score computation under the selected release configuration. Such benchmarking demonstrates that the disclosed spectral audit is not merely theoretical, but is also suitable for high-volume certificate or key-population screening.

In one benchmark embodiment, the disclosed audit processes approximately 9.5×10\hat{ }4 moduli per second on an NVIDIA A100 graphics-processing unit, with p95 service latency of approximately 14 ms in a service configuration. In another benchmark embodiment, CPU fallback throughput is approximately 7.2×10\hat{ }3 moduli per second.

In one reference-corpus benchmark embodiment, no false positives were observed on a certified reference corpus including approximately 10\hat{ }8 reference instances under the applicable release configuration.

In one blind-test benchmark embodiment, a mixed corpus including legitimate and hidden suspicious keys yielded detection of the hidden suspicious keys with no observed false positives among the legitimate keys.

In some embodiments, a release-validation process may be used before deployment. Such a process may include generating or loading the fixed reference spectrum, setting the threshold for the release, auditing one or more reference corpora, auditing one or more suspicious corpora, confirming numerical stability, and recording the release identifier, threshold, eigenvalue count, and associated validation metadata. The resulting release package may then be deployed consistently across one or more audit environments.

In certain embodiments, the system may maintain an audit record for each processed modulus. The audit record may include one or more of modulus identifier, source identifier, modulus size, score, threshold, reference release identifier, eigenvalue count, classification result, timestamp, hardware profile, numerical configuration, and recommended follow-up action. The specific audit record format is implementation-dependent.

In some embodiments, the audit record may be written to a local log, a centralized compliance database, a certificate monitoring stream, a key-management record, or a hardware security module audit trail. In some implementations, the record may be cryptographically signed, attested, sealed, or otherwise protected. Such logging and attestation features are optional deployment embodiments.

In one preferred deployment embodiment, the system is integrated into a key-generation workflow, including in certain embodiments a PKCS #11 environment. A candidate RSA keypair is generated, the modulus is extracted, and the disclosed spectral audit is applied before the keypair is returned to the requesting application. If the modulus passes, the keypair is released. If the modulus is flagged, the system may reject the candidate, regenerate internally, or otherwise invoke policy-controlled remediation, thereby preventing suspicious moduli from entering service.

In another embodiment, the system is deployed as a certificate-audit service. Certificates are ingested from a certificate store, certificate-authority database, transparency feed, or equivalent source, the corresponding RSA moduli are extracted, and each modulus is audited according to the disclosed spectral kernel. Flagged certificates may then be escalated, reissued, revoked, quarantined, or subjected to further investigation.

In another embodiment, the system is deployed in connection with smart-card or device vetting. Public keys are extracted from cards, tokens, embedded devices, or similar hardware artifacts, and the corresponding moduli are processed through the disclosed audit. Devices associated with flagged moduli may then be rejected, quarantined, or traced to a defective or compromised supply source.

In another embodiment, the system is deployed as a microservice or network-accessible audit engine. A client may transmit a modulus or a structure containing a modulus, such as a certificate or public-key object, to an audit endpoint. The service computes the score, applies the release threshold, and returns a structured PASS or FLAG result together with optional metadata.

In one service embodiment, the returned result may include one or more of a score field, a result field, an eigenvalues-computed field, a threshold field, and a latency field. By way of example, a response may report a score of 0.0018, a PASS result, an eigenvalue count of 256, a threshold of 0.007, and measured service latency.

In another embodiment, the system is deployed as a local audit tool, such as a command-line executable or equivalent utility. A user may invoke the tool on one or more files or key objects, and the tool may output the score, threshold, classification, and optional recommendation. This embodiment is useful for local compliance testing, incident response, and key inventory review.

In another embodiment, the system is embedded into a hardware security module or a key-management appliance. The module may compute the disclosed spectral audit before permitting a generated or imported RSA modulus to enter service. In such embodiments, a signed or attested audit record may also be generated.

The foregoing deployment arrangements illustrate that the same audit kernel may be packaged in different ways without changing the underlying invention. The invention does not depend on a specific user interface, service architecture, file format, or deployment topology.

In preferred embodiments, the disclosed scoring and threshold framework is supported by machine-checked formalization. In one such formalization, score_nonneg establishes that S(N) is nonnegative, threshold_fixed establishes that tau=0.007 for the release configuration, threshold_positive establishes that tau is positive, and parameter_free establishes that the threshold remains fixed without per-key tuning. Such formal anchors strengthen technical rigor and support disciplined deployment of the disclosed audit framework.

In preferred embodiments, mathematical formalization and empirical benchmark validation are maintained as distinct support categories, with the former establishing structural properties of the scoring framework and the latter establishing observed performance, throughput, and detection behavior under benchmark conditions.

In addition to the demonstrated and preferred embodiments described above, the specification preserves alternative and future-facing embodiments. For example, the disclosed operator-centered spectral audit framework may be adapted in later work to other cryptographic domains, other key types, batch-family analysis workflows, dedicated hardware accelerators, or related systems. Such embodiments are preserved as optional, alternative, prophetic, or continuation-oriented matter and should not be understood to redefine the core invention disclosed herein.

The disclosed system may therefore be understood as providing a real make-and-use audit workflow comprising obtaining an RSA modulus, embedding the modulus into a recognition-operator spectral problem, computing a modulus-dependent eigen-spectrum, comparing the resulting spectrum with a fixed prime-like reference, computing a scalar spectral-factor score, applying a fixed classification threshold, and generating a PASS or FLAG output, optionally together with logging, recommendation, policy action, or deployment-specific control.

Although numerous embodiments and examples have been described, the invention is not limited to the specific implementation details recited above except as required by the claims. The scope of the invention is defined by the claims and encompasses implementations that preserve the disclosed spectral audit kernel and its non-factorization classification function.

What is claimed is:

1. A computer-implemented method for auditing an RSA modulus N without factorization, the method comprising:
obtaining the RSA modulus N;
constructing a modulus-dependent spectral problem by applying periodic boundary conditions having period N to a recognition operator;
computing a plurality of eigenvalues of the modulus-dependent spectral problem;
comparing the plurality of eigenvalues to a stored prime-like reference spectrum;
computing, based on the comparing, a spectral-factor score representing deviation of the RSA modulus N from the stored prime-like reference spectrum; and
classifying the RSA modulus N according to the spectral-factor score.

2. The method of claim 1, wherein the recognition operator is:
H_RP=−(d2/dx2)+cosh(x)−1.

3. The method of claim 1, wherein constructing the modulus-dependent spectral problem comprises restricting the recognition operator to an interval [0, N).

4. The method of claim 1, wherein applying the periodic boundary conditions comprises applying:
psi(x+N)=psi(x), and
d/dx psi(x+N)=d/dx psi(x).

5. The method of claim 1, wherein the spectral-factor score S(N) is computed according to:
S(N)=sqrt((1/K)*sum_{k=1 . . . K} (lambda_k(N)−lambda_k_ref)\hat{ }2),
where lambda_k(N) denotes a computed eigenvalue of the modulus-dependent spectral problem and lambda_k_ref denotes a corresponding value of the stored prime-like reference spectrum.

6. The method of claim 1, wherein the stored prime-like reference spectrum is fixed for a release.

7. The method of claim 1, wherein classifying the RSA modulus N comprises:
assigning a PASS result when the spectral-factor score is less than or equal to a threshold tau; and
assigning a FLAG result when the spectral-factor score is greater than the threshold tau.

8. The method of claim 7, wherein the threshold tau is fixed per release, is not tuned on a per-key or per-key-size basis, and is selected from a certified prime-like reference distribution.

9. The method of claim 8, wherein tau=0.007.

10. The method of claim 1, wherein computing the plurality of eigenvalues comprises discretizing the modulus-dependent spectral problem on a finite grid and applying a Lanczos-Krylov eigenvalue procedure.

11. The method of claim 10, wherein the finite grid comprises 2\hat{ }14 grid points and the Lanczos-Krylov eigenvalue procedure comprises 256 iterations, selective reorthogonalization, Ritz value extraction, and FFT-based matrix-vector operations.

12. The method of claim 1, wherein the method is deterministic under a fixed release configuration such that a same RSA modulus N produces a same spectral-factor score and a same classification result.

13. The method of claim 1, further comprising processing a plurality of RSA moduli, computing a respective spectral-factor score for each RSA modulus, and performing cross-modulus spectral-correlation analysis to detect shared-factor families, related generation defects, or family-level anomalies, including when one or more individual spectral-factor scores are below a primary classification threshold.

14. The method of claim 1, further comprising extracting RSA moduli from certificates obtained from a certificate authority database or a certificate-transparency feed, performing the method of claim 1 for each extracted RSA modulus, and identifying one or more certificates associated with RSA moduli classified as FLAG.

15. The method of claim 1, further comprising extracting RSA public keys from devices or smart cards, obtaining RSA moduli from the extracted RSA public keys, performing the method of claim 1 for each obtained RSA modulus, and identifying one or more devices or smart cards associated with RSA moduli classified as FLAG.

16. A cryptographic audit system comprising:
an input module configured to receive an RSA modulus N;
an embedding engine configured to construct a modulus-dependent spectral problem by applying periodic boundary conditions having period N to a recognition operator;
an eigenvalue computation engine configured to compute a plurality of eigenvalues of the modulus-dependent spectral problem;
a reference spectrum store configured to store a prime-like reference spectrum;
a score engine configured to compare the plurality of eigenvalues to the stored prime-like reference spectrum and compute a spectral-factor score representing deviation of the RSA modulus N from the stored prime-like reference spectrum; and
a classifier configured to classify the RSA modulus N according to the spectral-factor score without factorization of the RSA modulus N.

17. The system of claim 16, wherein the system is implemented as a command-line audit tool, a network-accessible microservice, a PKCS #11 plugin, or an HSM-integrated audit module.

18. A non-transitory computer-readable medium storing instructions that, when executed by one or more processors, cause the one or more processors to perform the method of claim 1.

19. A method of controlling RSA key generation, the method comprising:
generating a candidate RSA keypair having a modulus N;
auditing the modulus N according to the method of claim 1 before releasing the candidate RSA keypair; and
releasing the candidate RSA keypair only if the modulus N is classified as PASS.

20. The method of claim 19, further comprising, in response to the modulus N being classified as FLAG, regenerating a replacement candidate RSA keypair.
